(19) United States
(12) Patent Application Publication
(10) Pub. No.: US 2025/0062345 A1
(43) Pub. Date: Feb. 20, 2025

(54) POSITIVE ELECTRODE FOR SECONDARY BATTERY AND SECONDARY BATTERY

(71) Applicant: MURATA MANUFACTURING CO., LTD., Kyoto (JP)

(72) Inventor: Yuichiro HASHIZUME, Kyoto (JP)

(21) Appl. No.: 18/938,726

(22) Filed: Nov. 6, 2024

Related U.S. Application Data
(63) Continuation of application No. PCT/JP2023/039363, filed on Nov. 1, 2023.

(30) Foreign Application Priority Data
Nov. 24, 2022 (JP) 2022-187183

(51) Int. Cl. H01M 4/58; H01M 4/02; H01M 4/36; H01M 4/62; H01M 10/0525

(52) U.S. Cl. CPC H01M 4/5825; H01M 4/366; H01M 4/622; H01M 4/625; H01M 10/0525; H01M 2004/021; H01M 2004/028

(57) ABSTRACT

A secondary battery includes: a positive electrode including a positive electrode active material layer; a negative electrode; and an electrolytic solution, in which the positive electrode active material layer includes: a plurality of positive electrode active material particles; and a dispersant. Each of the plurality of positive electrode active material particles includes an olivine type iron-containing phosphate compound, and the dispersant includes a carboxymethylcellulose salt. The plurality of positive electrode active material particles has a volume-based average particle size of 0.6 μm or more, and the dispersant has a weight average molecular weight in terms of polyethylene oxide/polyethylene glycol that satisfies a relationship represented by a formula (1).

M≤135106×D+548936 (1)
(M represents a weight average molecular weight in terms of polyethylene oxide/polyethylene glycol of a dispersant; and D represents a volume-based average particle size of a plurality of positive electrode active material particles.)

### CROSS REFERENCE TO RELATED APPLICATIONS

The present application is a continuation of International patent application no. PCT/JP2023/039363, filed Nov. 1, 2023, which claims priority to Japanese patent application no. 2022-187183, filed on Nov. 24, 2022, the entire contents of which are incorporated herein by reference.

### BACKGROUND

The present technology relates to a positive electrode for a secondary battery and a secondary battery.

Since various electronic devices such as mobile phones have been widely used, a secondary battery, which is smaller in size and lighter in weight and allows for a higher energy density, is under development as a power source. The secondary battery includes a positive electrode (positive electrode for a secondary battery), a negative electrode, and an electrolytic solution, and various considerations have been given to the configuration of the secondary battery.

Specifically, the positive electrode contains a positive electrode active material (lithium-containing metal phosphate compound having an olivine structure), a water-soluble thickener (carboxymethyl cellulose), and a binder, and the average polymerization degree of the carboxymethyl cellulose is specified. In addition, the positive electrode contains a positive electrode active material (lithium iron phosphate material), a conductor (carbon black and graphite), a water-soluble thickener, and a binder.

### SUMMARY

The present technology relates to a positive electrode for a secondary battery and a secondary battery.

Various studies on the configuration of the secondary battery have been made, but the battery characteristics of the secondary battery are still insufficient, and therefore there is room for improvement.

A positive electrode for a secondary battery and a secondary battery that can obtain excellent battery characteristics are desired.

In an embodiment of the present technology, a positive electrode for a secondary battery includes a positive electrode active material layer, in which the positive electrode active material layer includes: a plurality of positive electrode active material particles; and a dispersant. Each of the plurality of positive electrode active material particles includes an olivine type iron-containing phosphate compound, and the dispersant includes a carboxymethylcellulose salt. The plurality of positive electrode active material particles has a volume-based average particle size of 0.6 μm or more, and the dispersant has a weight average molecular weight in terms of polyethylene oxide/polyethylene glycol that satisfies a relationship represented by a formula (1).

$$M \leq 135106 \times D + 548936 \qquad ( 1 )$$

(M represents a weight average molecular weight in terms of polyethylene oxide/polyethylene glycol of a dispersant; and D represents a volume-based average particle size of a plurality of positive electrode active material particles.)

In an embodiment of the present technology, a secondary battery includes a positive electrode, a negative electrode, and an electrolytic solution, and the positive electrode has a configuration similar to the configuration of the above-described positive electrode for a secondary battery of an embodiment of the present technology.

The “olivine type iron-containing phosphate compound” is a phosphate compound having an olivine-type crystal structure and containing iron as a constituent element. Details of the configuration of the olivine type iron-containing phosphate compound will be described later.

In addition, the “volume-based average particle size of a plurality of positive electrode active material particles” is measured by analyzing the plurality of positive electrode active material particles, and the “weight average molecular weight in terms of polyethylene oxide/polyethylene glycol of a dispersant” is measured by analyzing the dispersant. Details of each of the analysis procedure of the plurality of positive electrode active material particles (measurement procedure of the average particle size) and the analysis procedure of the dispersant (measurement procedure of the weight average molecular weight) will be described later.

According to the positive electrode for a secondary battery and the secondary battery of an embodiment of the present technology, the positive electrode active material layer includes: a plurality of positive electrode active material particles; and a dispersant, each of the plurality of positive electrode active material particles includes an olivine type iron-containing phosphate compound, the dispersant includes a carboxymethylcellulose salt, the plurality of positive electrode active material particles has a volume-based average particle size of 0.6 μm or more, and the dispersant has a weight average molecular weight in terms of polyethylene oxide/polyethylene glycol that satisfies a relationship represented by the formula (1). Therefore, excellent battery characteristics can be obtained.

The effect of the present technology is not necessarily limited to the effect described herein, and may be any effect of a series of effects relating to the present technology described later.

### BRIEF DESCRIPTION OF THE FIGURES

FIG. 1 is a sectional view illustrating the configuration of a positive electrode for a secondary battery in an embodiment of the present technology.

FIG. 2 is a sectional view illustrating the configuration of a secondary battery in an embodiment of the present technology.

FIG. 3 is a sectional view illustrating the configuration of the battery element illustrated in FIG. 2.

FIG. 4 is a block diagram illustrating the configuration of an application example of a secondary battery.

FIG. 5 is a sectional view illustrating the configuration of a secondary battery for a test.

FIG. 6 is a graph showing a correlation between the volume-based average particle size of a plurality of positive electrode active material particles and the weight average molecular weight in terms of polyethylene oxide/polyethylene glycol of a dispersant.

### DETAILED DESCRIPTION

The present technology will be described in further detail including with reference to the drawings according to an embodiment.

First, the positive electrode for a secondary battery (hereinafter, simply referred to as “positive electrode”) of an embodiment of the present technology will be described.

The positive electrode described herein is used for a secondary battery as an electrochemical device. However, the positive electrode may be used for an electrochemical device other than a secondary battery. Specific examples of other electrochemical devices include a primary battery and a capacitor.

The positive electrode occludes and releases an electrode reactant during operation of the electrochemical device (during electrode reaction). The type of the electrode reactant is not particularly limited, but is specifically a light metal such as an alkali metal and an alkaline earth metal. Specific examples of the alkali metal include lithium, sodium, and potassium, and specific examples of the alkaline earth metal include beryllium, magnesium, and calcium.

Hereinafter, a case where the electrode reactant is lithium will be described as an example. As a result, in the positive electrode, lithium is occluded and released in an ionic state during electrode reaction.

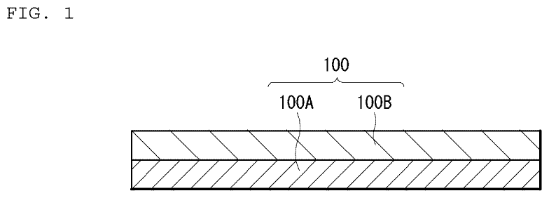

FIG. 1 illustrates the sectional configuration of a positive electrode 100, which is a specific example of the positive electrode. As illustrated in FIG. 1, the positive electrode 100 includes a positive electrode current collector 100A and a positive electrode active material layer 100B.

As illustrated in FIG. 1, the positive electrode current collector 100A is a conductive support that supports the positive electrode active material layer 100B, and has a pair of surfaces (upper surface and lower surface) on which the positive electrode active material layer 100B is provided. The positive electrode current collector 100A contains a conductive material such as a metal material, and specific examples of the conductive material include aluminum.

As illustrated in FIG. 1, the positive electrode active material layer 100B is a layer that occludes and releases lithium, and is provided on one surface (upper surface or lower surface) of the positive electrode current collector 100A. However, the positive electrode active material layer 100B may be provided on both surfaces (upper surface and lower surface) of the positive electrode current collector 100A.

The positive electrode active material layer 100B contains: a plurality of particulate positive electrode active materials (hereinafter, referred to as “a plurality of positive electrode active material particles”) that occludes and releases lithium; and a dispersant. More specifically, the positive electrode active material layer 100B further contains a positive electrode binder and a positive electrode conductor.

Each of the plurality of positive electrode active material particles includes any one kind or two or more kinds of olivine type iron-containing phosphate compounds. As described above, the olivine type iron-containing phosphate compound has an olivine-type crystal structure and contains iron as a constituent element.

Each of the plurality of positive electrode active material particles includes an olivine type iron-containing phosphate compound, because the crystal structure of the olivine type iron-containing phosphate compound is strong and stable. As a result, oxygen release from the olivine type iron-containing phosphate compound is suppressed. Therefore, the secondary battery using the positive electrode 100 has a stable battery capacity and is improved in safety.

Here, as described above, since the electrode reactant is lithium, the olivine type iron-containing phosphate compound is a phosphate compound containing lithium and iron as constituent elements. The type of the olivine type iron-containing phosphate compound is not particularly limited as long as it is a phosphate compound containing lithium and iron as constituent elements.

The olivine type iron-containing phosphate compound may further include one kind or two or more kinds of metal elements (excluding iron) as a constituent element. The type of the metal element is not particularly limited, and specific examples thereof include manganese, cobalt, nickel, titanium, chromium, vanadium, zinc, tin, tungsten, zirconium, magnesium, and aluminum.

Here, it is assumed that the sum of the content of iron in the olivine type iron-containing phosphate compound and the content of the one kind or two or more kinds of metal elements in the olivine type iron-containing phosphate compound is 100 parts by mol. In this case, the content of iron in the olivine type iron-containing phosphate compound is not particularly limited, but is particularly preferably 10 to 90 parts by mol. This is because the electron conductivity of the olivine type iron-containing phosphate compound is sufficiently improved. As a result, improvement in the electron conductivity of the plurality of positive electrode active material particles and stabilization of the operation potential and the battery capacity in the secondary battery using the positive electrode 100 are both achieved.

More specifically, the olivine type iron-containing phosphate compound preferably contains any one kind or two or more kinds of compounds represented by the formula (10). In particular, in the formula (10), y preferably satisfies 0.1≤y≤0.9.

LiₓFe_{y}M_{z}PO₄ (10)

(M is at least one of Mn, Co, Ni, Ti, Cr, V, Zn, Sn, W, Zr, Mg, and Al; and x, y, and z satisfy 0.9≤x≤1.1, 0<y≤1, 0≤z<1, and y+z=1.)

Specific examples of the olivine type iron-containing phosphate compound include LiFePO₄, LiFe_{0.5}Mn_{0.5}PO₄, and LiFe_{0.5}Co_{0.5}PO₄.

Here, the average particle size (volume-based average particle size) D of the plurality of positive electrode active material particles is 0.6 μm or more. The average particle size D is a so-called median diameter D50.

The average particle size D is 0.6 μm or more, because a positive electrode mixture slurry having excellent dispersibility and excellent fluidity is prepared in the manufacturing process of the positive electrode 100 (preparation process of the positive electrode mixture slurry), and the positive electrode active material layer 100B having excellent flatness is formed. Details of the reason described here will be described later.

The average particle size D is particularly preferably 23 μm or less. This is because the prepared positive electrode mixture slurry has sufficiently excellent dispersibility and sufficiently excellent fluidity, and the formed positive electrode active material layer 100B has sufficiently excellent flatness.

In particular, the average particle size D is more preferably 4 μm to 15 μm or less. This is because the positive electrode mixture slurry is further improved in each of dispersibility and fluidity, and the positive electrode active material layer 100B is further improved in flatness.

When the average particle size D is measured, the average particle size D is calculated by analyzing the plurality of positive electrode active material particles by using a particle size analyzer. As the particle size analyzer, a laser diffraction/scattering particle size distribution analyzer LA-960, which is manufactured by HORIBA, Ltd., or the like can be used.

More specifically, when the average particle size D is measured, first, the positive electrode 100 is charged in an aqueous solvent to peel the positive electrode active material layer 100B from the positive electrode current collector 100A. The type of the aqueous solvent is not particularly limited. Specific examples thereof include pure water, which is capable of dissolving the positive electrode binder. The type of the aqueous solvent described here is applied hereinafter. Subsequently, after the positive electrode active material layer 100B is charged into an aqueous solvent and the aqueous solvent is stirred, the aqueous solvent is filtered. As a result, since each of the positive electrode binder and the dispersant is dissolved and removed, the solid content (the plurality of positive electrode active material particles and the positive electrode conductor) is recovered.

Subsequently, the solid content is charged into an aqueous solvent, and then the solid content in the aqueous solvent is centrifuged by using a centrifugal separator. As a result, since the plurality of positive electrode active material particles is separated from the positive electrode conductor, the plurality of positive electrode active material particles is recovered. Finally, the average particle size D is measured by analyzing the plurality of positive electrode active material particles by using a particle size analyzer.

The positive electrode binder includes any one kind or two or more kinds of copolymers of an acrylic acid ester and acrylonitrile. This is because when the voltage of the secondary battery using the positive electrode 100 increases, decomposition of the positive electrode binder is suppressed.

The type of the acrylic acid ester is not particularly limited, and may be only one kind or two or more kinds. As an example, specific examples of the acrylic acid ester include methyl acrylate and ethyl acrylate, and other acrylic acid esters may also be used. The copolymerization amount of acrylonitrile in the copolymer is not particularly limited, and can be arbitrarily set.

In the positive electrode active material layer 100B, the content of the positive electrode binder is not particularly limited, but is particularly preferably 0.5 to 4 wt %. This is because a decrease in the conductivity of the positive electrode 100 is suppressed.

Specifically, when the content of the positive electrode binder is less than 0.5 wt % in the positive electrode active material layer 100B, the binding property of the plurality of positive electrode active material particles and the like using the positive electrode binder is insufficient. As a result, the positive electrode active material layer 100B is peeled off from the positive electrode current collector 100A, so that the conductivity of the positive electrode 100 may be reduced.

On the other hand, when the content of the positive electrode binder is more than 4 wt % in the positive electrode active material layer 100B, the proportion of the low conductive component (positive electrode binder) contained in the positive electrode active material layer 100B increases, so that the conductivity of the positive electrode 100 may decrease.

The procedure for examining the content of the positive electrode binder in the positive electrode active material layer 100B is as described below.

First, the positive electrode current collector 100A is peeled off from the positive electrode active material layer 100B, and then the weight of the positive electrode active material layer 100B is measured. Subsequently, the weight of the positive electrode binder contained in the positive electrode active material layer 100B is calculated by analyzing the positive electrode active material layer 100B using thermogravimetric analysis (TGA). As an example, when the thermal decomposition temperature of the positive electrode binder is about 300 to 600° C., the positive electrode active material layer 100B is heated at a heating rate=1° C./min, and the weight of the positive electrode binder is calculated based on the weight reduction rate in the range in which the heating temperature is about 300 to 600° C. Finally, the content of the positive electrode binder in the positive electrode active material layer 100B is calculated based on the weight of the positive electrode active material layer 100B and the weight of the positive electrode binder.

The positive electrode conductor includes any one kind or two or more kinds of conductive materials such as a carbon material, a metal material, and a conductive polymer compound.

Among others, it is preferable that the positive electrode conductor includes a carbon material. This is because the conductivity of the positive electrode active material layer 100B is sufficiently improved, and the carbon material also functions as a positive electrode active material. Specific examples of the carbon material include graphite, carbon black, acetylene black, and Ketjen black.

In the positive electrode active material layer 100B, the content of the positive electrode conductor is not particularly limited, but is particularly preferably 0.5 to 3 wt %. This is because the temporal stability of the positive electrode mixture slurry is improved in the manufacturing process of the positive electrode 100, and the conductivity of the positive electrode 100 is sufficiently improved.

Specifically, when the content of the positive electrode conductor is less than 0.5 wt % in the positive electrode active material layer 100B, the proportion of the conductive component (positive electrode conductor) contained in the positive electrode active material layer 100B decreases, so that the conductivity of the positive electrode 100 may decrease.

On the other hand, when the content of the positive electrode conductor is more than 3 wt % in the positive electrode active material layer 100B, the fluidity of the positive electrode mixture slurry is reduced in the manufacturing process of the positive electrode 100, and thus the temporal stability of the positive electrode mixture slurry may be reduced.

The procedure for examining the content of the positive electrode conductor in the positive electrode active material layer 100B is as described below. Hereinafter, a case where the positive electrode conductor is a carbon material will be described.

First, the positive electrode current collector 100A is peeled off from the positive electrode active material layer 100B, and then the weight of the positive electrode active material layer 100B is measured.

Subsequently, the positive electrode active material layer 100B is immersed in an organic solvent to dissolve the positive electrode binder contained in the positive electrode active material layer 100B. Specific examples of the organic solvent include any one kind or two or more kinds of N-methyl-2-pyrrolidone, dimethylformamide, dimethyl sulfoxide, and the like. Subsequently, the solution is filtered to recover the residue, and then the residue is dried.

Subsequently, the residue is immersed in an aqueous solvent to dissolve the dispersant contained in the residue. Specific examples of the aqueous solvent include water. Subsequently, the residue is filtered to recover the residue, and then the residue is dried.

Subsequently, the residue is subjected to carbon analysis to calculate the weight of the carbon component (positive electrode conductor) contained in the residue. As an analyzer for carbon analysis, a carbon-sulfur analyzer (CS meter) EMIA-920V2, which is manufactured by HORIBA, Ltd., or the like can be used.

Finally, the content of the positive electrode conductor in the positive electrode active material layer 100B is calculated based on the weight of the positive electrode active material layer 100B and the weight of the positive electrode conductor.

The dispersant is a material that improves the dispersibility of the plurality of positive electrode active material particles and the like when the positive electrode mixture slurry is prepared in the manufacturing process of the positive electrode 100.

The dispersant includes any one kind or two or more kinds of carboxymethylcellulose salts. This is because the dispersibility and fluidity of the positive electrode mixture slurry are sufficiently improved in the manufacturing process of the positive electrode 100.

The type of carboxymethylcellulose salt is not particularly limited, and specific examples thereof include a carboxymethylcellulose alkali metal salt and a carboxymethylcellulose alkaline earth metal salt. Specific examples of the carboxymethylcellulose alkali metal salt include lithium carboxymethylcellulose, sodium carboxymethylcellulose, and potassium carboxymethylcellulose. Specific examples of the carboxymethylcellulose alkaline earth metal salt include magnesium carboxymethylcellulose and calcium carboxymethylcellulose.

Among them, the carboxymethylcellulose salt preferably includes sodium carboxymethylcellulose. This is because the dispersibility and fluidity of the positive electrode mixture slurry are further improved.

Here, the dispersant has a weight average molecular weight (weight average molecular weight in terms of polyethylene oxide (PEO)/polyethylene glycol (PEG)) M that satisfies the relationship represented by the formula (1). In the formula (1), “D” is the average particle size D (μm) as described above. Hereinafter, the relationship shown in the formula (1) is referred to as “appropriate relationship”.

$$M \leq 135106 \times D + 548936 \qquad ( 1 )$$

(M represents a weight average molecular weight in terms of polyethylene oxide/polyethylene glycol of a dispersant; and D represents a volume-based average particle size of a plurality of positive electrode active material particles.)

The weight average molecular weight M satisfies the appropriate relationship because the weight average molecular weight M is optimized in the relationship with the average particle size D.

In this case, in the manufacturing process of the positive electrode 100 (preparation process of the positive electrode mixture slurry), it is suppressed that the dispersant unintentionally functions as an aggregating agent that makes the plurality of positive electrode active material particles crosslink and adsorb with each other, resulting in aggregation of the plurality of positive electrode active material particles through the dispersant. Accordingly, the plurality of positive electrode active material particles is sufficiently and uniformly dispersed, and therefore, a positive electrode mixture slurry having excellent dispersibility and excellent fluidity is prepared.

Moreover, on the surface of the positive electrode active material layer 100B formed using the positive electrode mixture slurry, irregularities resulting from coarse particles of the positive electrode active material particle are less likely to occur. Thus, the positive electrode active material layer 100B having excellent flatness (coatability) is formed. As a result, a secondary battery having excellent battery characteristics is realized using the positive electrode 100.

When the weight average molecular weight M is measured, the dispersant is analyzed using a gel permeation chromatography (GPC) apparatus to calculate the weight average molecular weight M. As the GPC apparatus, a high-speed GPC apparatus HLC-8320GPC, which is manufactured by Tosoh Techno-System, Inc., or the like can be used.

In this case, the setting is as follows: column=TSKgel guardocolumn PWXL (6.0 mmI.D.×4 cm)+TSKgel GMPWXL (7.8 mmI.D.×30 cm)×2, which is manufactured by Tosoh Techno-System, Inc., detector=RI detector polarity (+), eluent=0.1 M NaNO₃ aqueous solution, flow rate=1.0 ml/min (=1.0 cm³/min), concentration=0.2 mg/ml (=0.2 mg/cm³), injection amount=200 μl (=200×10⁻⁶ cm³), and column temperature=40° C.

More specifically, the procedure for measuring the weight average molecular weight M is as described below.

First, the positive electrode current collector 100A is peeled off from the positive electrode active material layer 100B, and then the positive electrode active material layer 100B is immersed in an organic solvent to dissolve the positive electrode binder contained in the positive electrode active material layer 100B. Details of the organic solvent capable of dissolving the positive electrode binder are as described above. Subsequently, the solution is filtered to recover the residue, and then the residue is dried.

Subsequently, the residue is immersed in an aqueous solvent to dissolve the dispersant contained in the residue. Details of the aqueous solvent capable of dissolving the dispersant are as described above. Subsequently, the solution is filtered to recover the filtrate, and then the filtrate is dried to recover the dispersant.

Subsequently, the dispersant is charged to an aqueous solvent, and then the aqueous solvent (temperature=80° C.) is stirred (stirring time=17 hours) to dissolve the dispersant in the aqueous solvent. The type of the aqueous solvent is not particularly limited, and specifically, is pure water or the like. Thus, a sample solution for analysis is prepared. Subsequently, the sample solution is gently shaken, and then the sample solution is filtered using a hydrophilic PTFE cartridge filter (pore size=0.45 μm). In this case, a trace amount of insoluble matter may be contained in the sample solution after filtration.

Finally, the weight average molecular weight M is measured by analyzing the sample solution using a GPC apparatus.

In this case, the weight average molecular weight M is measured using a calibration curve (tertiary approximate curve using standard PEO/PEG, which is manufactured by Agilent Technologies, Inc.). As a result, the value of the weight average molecular weight M becomes a value in terms of PEO/PEG.

In the positive electrode active material layer 100B, the content of the dispersant is not particularly limited, but is particularly preferably 0.6 to 2 wt %. This is because the temporal stability of the positive electrode mixture slurry is improved in the manufacturing process of the positive electrode 100, and the physical durability of the positive electrode active material layer 100B formed using the positive electrode mixture slurry is improved.

Specifically, when the content of the dispersant is less than 0.6 wt % in the positive electrode active material layer 100B, the fluidity of the positive electrode mixture slurry is reduced in the manufacturing process of the positive electrode 100, and thus the temporal stability of the positive electrode mixture slurry may be reduced.

On the other hand, when the content of the positive electrode binder is more than 2 wt % in the positive electrode active material layer 100B, the positive electrode active material layer 100B formed using the positive electrode mixture slurry becomes excessively hard, so that the physical durability of the positive electrode active material layer 100B may be deteriorated. In this case, the positive electrode active material layer 100B may be broken, and the positive electrode active material layer 100B may fall off from the positive electrode current collector 100A.

The procedure for examining the content of the dispersant in the positive electrode active material layer 100B is as described below.

First, the positive electrode current collector 100A is peeled off from the positive electrode active material layer 100B, and then the weight of the positive electrode active material layer 100B is measured. Subsequently, the positive electrode active material layer 100B is analyzed using a thermogravimetric analysis method in a nitrogen atmosphere to calculate the weight of the dispersant contained in the positive electrode active material layer 100B. As an example, when the thermal decomposition temperature of the dispersant is about 250° C., the positive electrode active material layer 100B is heated at a heating rate=1° C./min, and the weight of the dispersant is calculated based on the weight reduction rate in the range in which the heating temperature is room temperature to about 250° C. Finally, the content of the dispersant in the positive electrode active material layer 100B is calculated based on the weight of the positive electrode active material layer 100B and the weight of the dispersant.

In the positive electrode 100, during electrode reaction, lithium is released in an ionic state from the positive electrode active material layer 100B, and lithium is occluded in an ionic state in the positive electrode active material layer 100B.

The positive electrode 100 is manufactured by an example procedure described below according to an embodiment.

First, the plurality of positive electrode active material particles including an olivine type iron-containing phosphate compound, the positive electrode binder, the positive electrode conductor, and the dispersant including a carboxymethylcellulose salt are mixed with each other to obtain a positive electrode mixture.

In this case, as described above, the plurality of positive electrode active material particles to be used has an average particle size D of 0.6 μm or more, and the dispersant to be used has a weight average molecular weight M satisfying the appropriate conditions.

Subsequently, the positive electrode mixture is charged into an aqueous solvent to prepare a paste-like positive electrode mixture slurry. The type of the aqueous solvent is not particularly limited, and specifically, is pure water or the like, as described above.

Finally, the positive electrode mixture slurry is applied on one surface of the positive electrode current collector 100A to form the positive electrode active material layer 100B. Thereafter, the positive electrode active material layer 100B may be compression-molded using a roll press machine or the like. In this case, the positive electrode active material layer 21B may be heated or compression molding may be repeated a plurality of times.

As a result, the positive electrode active material layer 100B is formed on both surfaces of the positive electrode current collector 100A, so that the positive electrode 100 is completed.

According to the positive electrode 100, the positive electrode 100 contains a plurality of positive electrode active material particles (olivine type iron-containing phosphate compound) and a dispersant (carboxymethylcellulose salt), the average particle size D of the plurality of positive electrode active material particles is 0.6 μm or more, and the weight average molecular weight M of the dispersant satisfies the appropriate relationship.

In this case, as described above, the relationship between the average particle size D and the weight average molecular weight M is optimized, so that the following action can be obtained.

In the manufacturing process of the positive electrode 100 (preparation process of the positive electrode mixture slurry), it is suppressed that the dispersant unintentionally functions as an aggregating agent that makes the plurality of positive electrode active material particles crosslink and adsorb with each other, resulting in aggregation of the plurality of positive electrode active material particles through the dispersant. Accordingly, the plurality of positive electrode active material particles is sufficiently and uniformly dispersed, and therefore, a positive electrode mixture slurry having excellent dispersibility and excellent fluidity is prepared.

Moreover, on the surface of the positive electrode active material layer 100B formed using the positive electrode mixture slurry, irregularities resulting from coarse particles of the positive electrode active material particle are less likely to occur. Thus, the positive electrode active material layer 100B having excellent flatness (coatability) is formed.

From these, since the positive electrode active material layer 100B is favorably and stably formed using the positive electrode mixture slurry, a secondary battery having excellent battery characteristics can be realized using the positive electrode 100.

In particular, when the average particle size D is 23 μm, the prepared positive electrode mixture slurry has sufficiently excellent dispersibility and sufficiently excellent fluidity, and the formed positive electrode active material layer 100B has sufficiently excellent flatness, so that a higher effect can be obtained.

When the average particle size D is 4 to 15 μm, each of the dispersibility and the fluidity of the positive electrode mixture slurry is further improved, and the flatness of the positive electrode active material layer 100B is further improved, so that a high effect can be obtained.

When the content of the dispersant is 0.6 to 2 wt % in the positive electrode active material layer 100B, the temporal stability of the positive electrode mixture slurry is improved in the manufacturing process of the positive electrode 100, and the physical durability of the positive electrode active material layer 100B formed using the positive electrode mixture slurry is improved, so that a higher effect can be obtained.

When the olivine type iron-containing phosphate compound further contains one kind or two or more kinds of metal elements (excluding iron) as a constituent element, and the content of iron is 10 to 90 parts by mol in the olivine type iron-containing phosphate compound, the electron conductivity of the olivine type iron-containing phosphate compound is sufficiently improved, so that a higher effect can be obtained.

When the carboxymethylcellulose salt includes sodium carboxymethylcellulose, the dispersibility and fluidity of the positive electrode mixture slurry are further improved, so that a higher effect can be obtained.

When the positive electrode active material layer 100B further contains a positive electrode binder (copolymer of an acrylic acid ester and acrylonitrile), and the content of the positive electrode binder is 0.5 to 4 wt % in the positive electrode active material layer 100B, a decrease in conductivity of the positive electrode 100 is suppressed, so that a higher effect can be obtained.

When the positive electrode active material layer 100B further contains a positive electrode conductor (carbon material), and the content of the positive electrode conductor is 0.5 to 3 wt % in the positive electrode active material layer 100B, the temporal stability of the positive electrode mixture slurry is improved in the manufacturing process of the positive electrode 100, and the conductivity of the positive electrode 100 is sufficiently improved, so that a higher effect can be obtained.

The secondary battery of an embodiment of the present technology to which the positive electrode 100 is applied will be described.

The secondary battery described herein is a secondary battery that can obtain a battery capacity by utilizing occlusion and release of an electrode reactant and includes a positive electrode, a negative electrode, and an electrolytic solution. Hereinafter, as described above, a case where the electrode reactant is lithium will be described as an example. A secondary battery in which the battery capacity is obtained by utilizing occlusion and release of lithium is a so-called lithium ion secondary battery. In the lithium ion secondary battery, lithium is occluded and released in an ionic state.

The charge capacity of the negative electrode is preferably larger than the discharge capacity of the positive electrode. That is, the electrochemical capacity per unit area of the negative electrode is preferably larger than the electrochemical capacity per unit area of the positive electrode. This is to prevent lithium from precipitating on the surface of the negative electrode during charging.

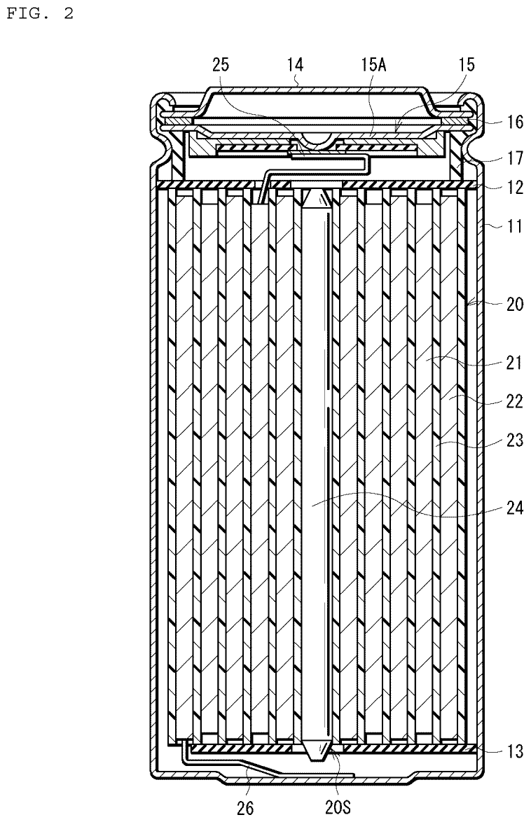

FIG. 2 illustrates the sectional configuration of the secondary battery, and FIG. 3 illustrates the sectional configuration of the battery element 20 illustrated in FIG. 2.

As illustrated in FIGS. 2 and 3, the secondary battery includes a battery can 11, a pair of insulating plates 12 and 13, a battery element 20, a positive electrode lead 25, and a negative electrode lead 26. The secondary battery described herein is a cylindrical secondary battery in which the battery element 20 is housed inside the battery can 11 having a cylindrical shape.

As illustrated in FIG. 2, the battery can 11 is a housing member that houses the battery element 20 and the like. Since the battery can 11 has one open end portion and the other closed end portion, the battery can 11 has a hollow structure. The battery can 11 contains any one kind or two or more kinds of metal materials such as iron, aluminum, an iron alloy, and an aluminum alloy. A metal material such as nickel may be plated on the surface of the battery can 11.

A battery cover 14, a safety valve mechanism 15, and a heat sensitive resistance element (PTC element) 16 are crimped to the open end portion of the battery can 11 with a gasket 17 interposed therebetween. The battery can 11 is thereby sealed by the battery cover 14. Here, the battery cover 14 contains the same material as the material for forming the battery can 11. The safety valve mechanism 15 and the PTC element 16 are provided inside the battery cover 14, and the safety valve mechanism 15 is electrically connected to the battery cover 14 with the PTC element 16 interposed therebetween. The gasket 17 contains an insulating material, and asphalt or the like may be applied to the surface of the gasket 17.

In the safety valve mechanism 15, when the internal pressure of the battery can 11 reaches a certain level or more due to an internal short circuit, external heating, and the like, a disk plate 15A is reversed, and thus the electrical connection between the battery cover 14 and the battery element 20 is disconnected. In order to prevent abnormal heat generation due to a large current, the electrical resistance of the PTC element 16 rises as the temperature rises.

As illustrated in FIG. 2, the insulating plates 12 and 13 are arranged so that the insulating plates 12 and 13 face each other with the battery element 20 interposed therebetween. Thus, the battery element 20 is sandwiched between the insulating plates 12 and 13.

As illustrated in FIGS. 2 and 3, the battery element 20 is a power generating element including a positive electrode 21, a negative electrode 22, a separator 23, and an electrolytic solution (not illustrated).

The battery element 20 is a so-called wound electrode body. That is, the positive electrode 21 and the negative electrode 22 are stacked with each other with the separator 23 interposed therebetween, and are wound while facing each other with the separator 23 interposed therebetween. A center pin 24 is inserted into a space 20S provided at the winding center of the battery element 20. It should be understood that the center pin 24 may be omitted.

The positive electrode 21 has the same configuration as the configuration of the positive electrode 100.

Specifically, as illustrated in FIG. 3, the positive electrode 21 includes a positive electrode current collector 21A and a positive electrode active material layer 21B. The configuration of the positive electrode current collector 21A is similar to the configuration of the positive electrode current collector 100A, and the configuration of the positive electrode active material layer 21B is similar to the configuration of the positive electrode active material layer 100B. Here, the positive electrode active material layer 21B is provided on both surfaces of the positive electrode current collector 21A.

As illustrated in FIG. 3, the negative electrode 22 includes a negative electrode current collector 22A and a negative electrode active material layer 22B.

The negative electrode current collector 22A has a pair of surfaces on which the negative electrode active material layer 22B is provided. The negative electrode current collector 22A contains a conductive material such as a metal material, and specific examples of the conductive material include copper.

The negative electrode active material layer 22B contains any one kind or two or more kinds of negative electrode active materials occluding and releasing lithium. It should be understood that the negative electrode active material layer 22B may further contain any one kind or two or more kinds of other materials such as a negative electrode binder and a negative electrode conductor. The method for forming the negative electrode active material layer 22B is not particularly limited, but is specifically any one kind or two or more kinds of a coating method, a gas phase method, a liquid phase method, a thermal spraying method, a firing method (sintering method), and the like.

Here, since the negative electrode active material layer 22B is provided on both surfaces of the negative electrode current collector 22A, the negative electrode 22 includes two negative electrode active material layers 22B. However, since the negative electrode active material layer 22B is provided only on one surface of the negative electrode current collector 22A on the side where the negative electrode 22 faces the positive electrode 21, the negative electrode 22 may include only one negative electrode active material layer 22B.

The type of the negative electrode active material is not particularly limited, and specific examples thereof include a carbon material, a metal-based material, and the like. This is because a high energy density can be obtained.

Specific examples of the carbon material include graphitizable carbon, non-graphitizable carbon, and graphite (natural graphite and artificial graphite).

The metal-based material is a material including any one kind or two or more kinds of metal elements and metalloid elements capable of forming an alloy with lithium as constituent elements, and specific examples of the metal elements and metalloid elements are silicon, tin, and the like. The metal-based material may be a simple substance, an alloy, a compound, a mixture of two or more kinds thereof, or a material including two or more phases thereof. However, since the simple substance may contain an arbitrary amount of impurities, the purity of the simple substance is not necessarily limited to 100%. Specific examples of the metal-based material include TiSi₂, SiOₓ (0<x≤2 or 0.2<x<1.4), and the like.

The negative electrode binder contains any one kind or two or more kinds of materials such as a synthetic rubber and a polymer compound. Specific examples of the synthetic rubber include styrene-butadiene rubber, fluorine rubber, and ethylene propylene diene. Specific examples of the polymer compound include polyvinylidene fluoride, polyimide, and carboxymethyl cellulose.

The negative electrode conductor contains any one kind or two or more kinds of conductive materials such as a carbon material, a metal material, and a conductive polymer compound, and specific examples of the carbon material include graphite, carbon black, acetylene black, and Ketjen black.

As illustrated in FIG. 3, the separator 23 is an insulating porous film interposed between the positive electrode 21 and the negative electrode 22, and allows lithium ions to pass therethrough while preventing contact (short circuit) between the positive electrode 21 and the negative electrode 22. The separator 23 contains a polymer compound such as polyethylene.

The electrolytic solution is a liquid electrolyte and is impregnated in each of the positive electrode 21, the negative electrode 22, and the separator 23. This electrolytic solution contains a solvent and an electrolyte salt.

The solvent contains any one kind or two or more kinds of non-aqueous solvents (organic solvents), and the electrolytic solution containing the non-aqueous solvent is a so-called non-aqueous electrolytic solution.

The non-aqueous solvent is an ester, an ether, or the like, and more specifically, is a carbonic acid ester-based compound, a carboxylic acid ester-based compound, a lactone-based compound, or the like. This is because dissociation of the electrolyte salt and mobility of the ions are improved.

The carbonic acid ester-based compound is a cyclic carbonic acid ester and a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic acid ester-based compound is a chain carboxylic acid ester or the like. Specific examples of the chain carboxylic acid ester include ethyl acetate, ethyl propionate, propyl propionate, and ethyl trimethylacetate.

The lactone-based compound is a lactone or the like. Specific examples of the lactone include γ-butyrolactone and γ-valerolactone.

The ether may be 1,2-dimethoxyethane, tetrahydrofuran, 1,3-dioxolane, 1,4-dioxane, or the like.

The non-aqueous solvent is an unsaturated cyclic carbonic acid ester, a fluorinated cyclic carbonic acid ester, a sulfonic acid ester, a phosphoric acid ester, an acid anhydride, a nitrile compound, an isocyanate compound, and the like. This is because electrochemical stability of the electrolytic solution is improved.

Specific examples of the unsaturated cyclic carbonic acid ester include vinylene carbonate, vinyl ethylene carbonate, and methylene ethylene carbonate. Specific examples of the fluorinated cyclic carbonic acid ester include ethylene monofluorocarbonate and ethylene difluorocarbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

The electrolyte salt contains any one kind or two or more kinds of light metal salts such as a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl) methide (LiC(CF₃SO₂)₃), lithium bis(oxalato) borate (LiB(C₂O₄)₂), lithium monofluorophosphate (Li₂PFO₃), and lithium difluorophosphate (LiPF₂O₂). This is because a high battery capacity can be obtained.

The content of the electrolyte salt is not particularly limited, and is specifically 0.3 to 3.0 mol/kg with respect to the solvent. This is because high ion conductivity can be obtained.

As illustrated in FIGS. 2 and 3, the positive electrode lead 25 is connected to the positive electrode current collector 21A of the positive electrode 21 and contains a conductive material such as aluminum. The positive electrode lead 25 is electrically connected to the battery cover 14 with the safety valve mechanism 15 interposed therebetween.

As illustrated in FIGS. 2 and 3, the negative electrode lead 26 is connected to the negative electrode current collector 22A of the negative electrode 22 and contains a conductive material such as nickel. The negative electrode lead 26 is electrically connected to the battery can 11.

The secondary battery operates as follows during charging and discharging according to an embodiment.

During charging, in the battery element 20, lithium is released from the positive electrode 21, and the lithium is occluded in the negative electrode 22 with the electrolytic solution interposed therebetween. On the other hand, during discharging, in the battery element 20, lithium is released from the negative electrode 22, and the lithium is occluded in the positive electrode 21 with the electrolytic solution interposed therebetween. At the time of charge and the time of discharge, lithium is occluded and released in an ionic state.

When the secondary battery is manufactured, according to an example procedure described below, a positive electrode 21 and a negative electrode 22 are produced, an electrolytic solution is prepared, then a secondary battery is assembled, and the assembled secondary battery is subjected to a stabilization treatment.

Using the same procedure as the production procedure of the positive electrode 100 described above, the positive electrode active material layer 21B is formed on both surfaces of the positive electrode current collector 21A to form the positive electrode 21.

The negative electrode 22 is formed by the same procedure as the production procedure of the positive electrode 21 described above. Specifically, first, a mixture (negative electrode mixture) in which a negative electrode active material, a negative electrode binder, and a negative electrode conductor are mixed together is charged into a solvent to prepare a paste-like negative electrode mixture slurry. Subsequently, the negative electrode mixture slurry is applied to both surfaces of the negative electrode current collector 22A to form the negative electrode active material layer 22B. Thereafter, the negative electrode active material layer 22B may be compression-molded. As a result, the negative electrode active material layer 22B is formed on both surfaces of the negative electrode current collector 22A, so that the negative electrode 22 is formed.

An electrolyte salt is charged into a solvent. As a result, the electrolyte salt is dispersed or dissolved in the solvent, thereby preparing an electrolytic solution.

First, the positive electrode lead 25 is connected to the positive electrode current collector 21A of the positive electrode 21 by a joining method such as a welding method, and the negative electrode lead 26 is connected to the negative electrode current collector 22A of the negative electrode 22 by a joining method such as a welding method. Subsequently, the positive electrode 21 and the negative electrode 22 are laminated on each other with the separator 23 interposed therebetween, and then the positive electrode 21, the negative electrode 22, and the separator 23 are wound to prepare a wound body (not illustrated) having a space 20S. This wound body has the same configuration as the configuration of the battery element 20 except that each of the positive electrode 21, the negative electrode 22, and the separator 23 is not impregnated with the electrolytic solution. Subsequently, the center pin 24 is inserted into the space 20S of the wound body.

Subsequently, the wound body and the insulating plates 12 and 13 are housed inside the battery can 11 in a state where the wound body is sandwiched between the insulating plates 12 and 13. In this case, the positive electrode lead 25 is connected to the safety valve mechanism 15 by a joining method such as a welding method, and the negative electrode lead 26 is connected to the battery can 11 by a joining method such as a welding method. Then, the wound body is impregnated with the electrolytic solution by injecting the electrolytic solution into the battery can 11. As a result, each of the positive electrode 21, the negative electrode 22, and the separator 23 is impregnated with the electrolytic solution, and thus the battery element 20 is prepared.

Finally, the battery cover 14, the safety valve mechanism 15, and the PTC element 16 are housed inside the battery can 11, and then the battery can 11 is crimped with the gasket 17 interposed therebetween. As a result, the battery cover 14, the safety valve mechanism 15, and the PTC element 16 are fixed to the battery can 11, and the battery element 20 is enclosed inside the battery can 11, so that the secondary battery is assembled.

The assembled secondary battery is charged and discharged. Various conditions such as an environmental temperature, the number of times of charge and discharge (the number of cycles), and charge and discharge conditions can be arbitrarily set. As a result, since a coating film is formed on the surface of each of the positive electrode 21 and the negative electrode 22, the state of the battery element 20 is electrochemically stabilized. Thus, the secondary battery is completed.

According to the secondary battery, the positive electrode 21 has the same configuration as the configuration of the positive electrode 100. Therefore, for the reasons described above, the positive electrode active material layer 21B is favorably and stably formed using the positive electrode mixture slurry, so that excellent battery characteristics can be obtained.

In particular, when the secondary battery is a lithium ion secondary battery, a sufficient battery capacity can be stably obtained using occlusion and release of lithium, so that a higher effect can be obtained.

Other actions and effects relating to the secondary battery are similar to the other actions and effects relating to the positive electrode 100.

The configuration of the above-described secondary battery can be appropriately changed as described below according to an embodiment. However, a series of modification examples described below may be combined with each other.

The separator 23 to be used was a porous film. However, although not specifically illustrated in the drawings, a laminated type separator including a polymer compound layer may be used.

Specifically, the laminated type separator includes a porous film having a pair of surfaces and a polymer compound layer provided on one surface or both surfaces of the porous film. This is because the adhesive property of the separator to each of the positive electrode 21 and the negative electrode 22 is improved, so that positional displacement of the battery element 20 (winding deviation of each of the positive electrode 21, the negative electrode 22, and the separator 23) is suppressed. Accordingly, when a decomposition reaction of the electrolytic solution occurs, swelling of the secondary battery is suppressed. The polymer compound layer contains a polymer compound such as polyvinylidene fluoride. This is because polyvinylidene fluoride or the like is excellent in physical strength, and electrochemically stable.

One or both of the porous film and the polymer compound layer may contain a plurality of insulating particles. This is because the plurality of insulating particles promotes heat dissipation at the time of heat generation of the secondary battery, thereby improving the safety (heat resistance) of the secondary battery. The plurality of insulating particles contains any one kind or two or more kinds of insulating materials such as an inorganic material and a resin material. Specific examples of the inorganic material include aluminum oxide, aluminum nitride, boehmite, silicon oxide, titanium oxide, magnesium oxide, and zirconium oxide. Specific examples of the resin material include an acrylic resin and a styrene resin.

When a laminated type separator is produced, a precursor solution containing a polymer compound, a solvent, and the like is prepared, and then the precursor solution is applied to one surface or both surfaces of the porous film. In this case, a plurality of insulating particles may be added to the precursor solution as necessary.

Also when the laminated type separator is used, lithium can move between the positive electrode 21 and the negative electrode 22, so that the same effect can be obtained. In this case, in particular, as described above, the safety of the secondary battery is improved, so that a higher effect can be obtained.

The electrolytic solution to be used was a liquid electrolyte. However, although not specifically illustrated in the drawings, an electrolyte layer that is a gel-like electrolyte may be used.

In the battery element 20 using an electrolyte layer, the positive electrode 21 and the negative electrode 22 are laminated on each other with the separator 23 and the electrolyte layer interposed therebetween, and the positive electrode 21, the negative electrode 22, the separator 23, and the electrolyte layer are wound. The electrolyte layer is interposed between the positive electrode 21 and the separator 23, and is interposed between the negative electrode 22 and the separator 23.

Specifically, the electrolyte layer contains an electrolytic solution and a polymer compound, and the electrolytic solution is held by the polymer compound. This is because leakage of the electrolytic solution is prevented. The configuration of the electrolytic solution is as described above. The polymer compound contains polyvinylidene fluoride or the like. When an electrolyte layer is formed, a precursor solution containing an electrolytic solution, a polymer compound, a solvent, and the like is prepared, and then the precursor solution is applied to one surface or both surfaces of each of the positive electrode 21 and the negative electrode 22.

Also when the electrolyte layer is used, lithium can move between the positive electrode 21 and the negative electrode 22 with the electrolyte layer interposed therebetween, so that the same effect can be obtained. In this case, in particular, as described above, leakage of the electrolytic solution is prevented, so that a higher effect can be obtained.

The application (application example) of the secondary battery is not particularly limited. The secondary battery to be used as a power source may be a main power source or an auxiliary power source in electronic devices, electric vehicles, and the like. The main power source is a power source that is preferentially used regardless of the presence or absence of another power source. The auxiliary power source may be a power source that is used instead of the main power source, or is a power source that is switched from the main power source.

Specific examples of the application of the secondary battery are as described below: electronic devices such as a video camera, a digital still camera, a mobile phone, a notebook personal computer, a headphone stereo, a portable radio, and a portable information terminal; storage devices such as a backup power source and a memory card; power tools such as an electric drill and an electric saw; a battery pack mounted on an electronic device or the like; medical electronic devices such as a pacemaker and a hearing aid; electric vehicles such as an electric car (including a hybrid car); and power storage systems such as a domestic or industrial battery system that stores electric power in preparation for emergency or the like. In these applications, one secondary battery may be used, or a plurality of secondary batteries may be used.

A single battery or an assembled battery may be used in the battery pack. The electric vehicle is a vehicle that travels using the secondary battery as a power source for driving, and may be a hybrid automobile including other driving source in addition to the secondary battery. In a home electric power storage system, home electric products and the like can be used using electric power accumulated in the secondary battery as an electric power storage source.

Here, application examples of the secondary battery will be specifically described. The configurations of the application examples described below are merely examples, and may be changed as appropriate.

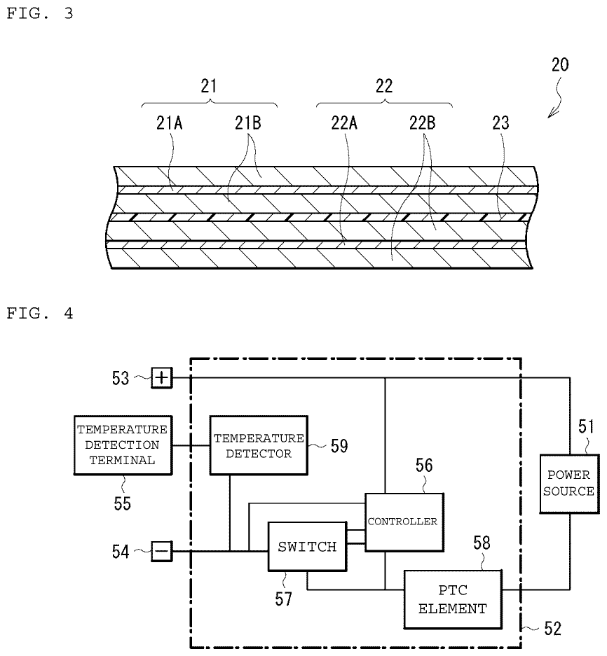

FIG. 4 illustrates the block configuration of a battery pack. The battery pack to be described herein is a battery pack including one secondary battery (so-called soft pack), and is mounted on an electronic device typified by a smartphone.

The battery pack includes a power source 51 and a circuit board 52, as illustrated in FIG. 4. The circuit board 52 is connected to the power source 51, and includes a positive electrode terminal 53, a negative electrode terminal 54, and a temperature detection terminal 55.

The power source 51 includes one secondary battery. In the secondary battery, a positive electrode lead is connected to the positive electrode terminal 53, and a negative electrode lead is connected to the negative electrode terminal 54. The power source 51 can be connected to the outside via the positive electrode terminal 53 and the negative electrode terminal 54, and thus can be charged and discharged. The circuit board 52 includes a controller 56, a switch 57, a PTC element 58, and a temperature detector 59. However, the PTC element 58 may be omitted.

The controller 56 includes a central processing unit (CPU), a memory, and the like, and controls the operation of the entire battery pack. The controller 56 performs detection and control of the use state of the power source 51 as necessary.

When the voltage of the power source 51 (secondary battery) reaches an overcharge detection voltage or an overdischarge detection voltage, the controller 56 disconnects the switch 57 so that a charge current does not flow through a current path of the power source 51. The overcharge detection voltage is not particularly limited, and is specifically 4.20 V±0.05 V. The overdischarge detection voltage is not particularly limited, and is specifically 2.40 V±0.1 V.

The switch 57 includes a charge control switch, a discharge control switch, a charge diode, a discharge diode, and the like, and switches connection or disconnection between the power source 51 and an external device according to an instruction of the controller 56. The switch 57 includes a field effect transistor (MOSFET) using a metal oxide semiconductor, and the like, and charge or discharge current is detected based on the ON resistance of the switch 57.

The temperature detector 59 includes a temperature detecting element such as a thermistor. The temperature detector 59 measures the temperature of the power source 51 using the temperature detection terminal 55 and outputs the measurement result of temperature to the controller 56. The measurement result of the temperature measured by the temperature detector 59 is used, when the controller 56 performs charge and discharge control during abnormal heat generation and when the controller 56 performs a correction process during calculating remaining capacity.

### EXAMPLES

Description will be given on examples of the present technology according to an embodiment.

### Examples 1 to 15 and Comparative Examples 1 to 8

As described below, after a secondary battery was manufactured, the battery characteristics of the secondary battery were evaluated.

### [Manufacture of Secondary Battery]

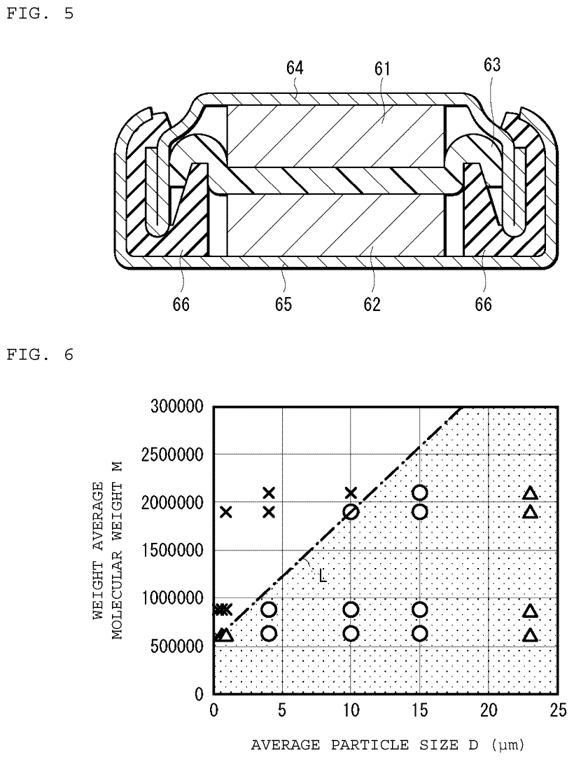

FIG. 5 illustrates the sectional configuration of a secondary battery for a test, and the secondary battery for a test is a so-called coin type secondary battery (lithium ion secondary battery).

As illustrated in FIG. 5, the secondary battery includes a test electrode 61, a counter electrode 62, a separator 63, an exterior cup 64, an exterior can 65, a gasket 66, and an electrolytic solution (not illustrated).

The test electrode 61 is accommodated in the exterior cup 64, and the counter electrode 62 is accommodated in the exterior can 65. The test electrode 61 and the counter electrode 62 are laminated on each other with the separator 63 interposed therebetween, and each of the test electrode 61, the counter electrode 62, and the separator 63 is impregnated with the electrolytic solution. Since the exterior cup 64 and the exterior can 65 are crimped to each other with the gasket 66 interposed therebetween, the test electrode 61, the counter electrode 62, and the separator 63 are enclosed by the exterior cup 64 and the exterior can 65.

The coin type secondary battery illustrated in FIG. 5 was produced according to the procedure described below.

### (Production of Test Electrode)

To prepare the test electrode 61, first, 94 parts by mass of a positive electrode active material (LiFePO₄ (LFP) as an olivine type iron-containing phosphate compound), 3 parts by mass of a positive electrode binder (copolymer of an acrylic acid ester and acrylonitrile (CAA), copolymerization amount of acrylonitrile: 30 wt %), 2 parts by mass of a positive electrode conductor (carbon black (CB)), and 1 part by mass of a dispersant (sodium carboxymethylcellulose (CMCNa) as a carboxymethylcellulose salt) were mixed with each other to obtain a positive electrode mixture. Subsequently, the positive electrode mixture was charged into a solvent (pure water as an aqueous solvent), and then the solvent was stirred to prepare a paste-like positive electrode mixture slurry.

Subsequently, the positive electrode mixture slurry was applied (application amount=22 mg/cm²) to one surface of a positive electrode current collector 21A (strip-shaped aluminum foil having a thickness=12 μm) using a coating apparatus, and then the positive electrode mixture slurry was dried to form a positive electrode active material layer 21B. Finally, the positive electrode active material layer 21B was compression-molded (volume density=2.1 g/cm³) using a roll pressing machine, and then the positive electrode current collector 21A having the positive electrode active material layer 21B formed thereon was punched into a disk shape (diameter=16.5 mm). Thereby, the test electrode 61 was produced.

### (Production of Counter Electrode)

A lithium metal plate was punched into a disk shape (diameter=17 mm). Thereby, the counter electrode 62 was obtained.

### (Preparation of Electrolytic Solution)

An electrolyte salt (lithium hexafluorophosphate (LiPF₆)) was added into a solvent (ethylene carbonate as a cyclic carbonic acid ester and diethyl carbonate as a chain carbonic acid ester), and the solvent was stirred. In this case, the mixing ratio (weight ratio) of the solvent was ethylene carbonate:diethyl carbonate=30:70, and the content of the electrolyte salt in the electrolytic solution was 1 mol/kg with respect to the solvent. Thereby, the electrolytic solution was prepared.

### (Assembly of Secondary Battery)

First, the test electrode 61 was accommodated in the exterior cup 64, and the counter electrode 62 was accommodated in the exterior can 65. Subsequently, the test electrode 61 accommodated in the exterior cup 64 and the counter electrode 62 accommodated in the exterior can 65 were laminated on each other with the separator 63 (microporous polyethylene film having a thickness=20 μm and a diameter=17.5 mm) impregnated with the electrolytic solution interposed therebetween. Subsequently, in a state where the test electrode 61 and the counter electrode 62 were laminated on each other with the separator 63 interposed therebetween, the exterior cup 64 and the exterior can 65 were crimped to each other with the gasket 66 interposed therebetween. As a result, the test electrode 61 and the counter electrode 62 were enclosed in the exterior cup 64 and the exterior can 65, so that the secondary battery was assembled. Finally, the assembled secondary battery was allowed to stand still (standing time=10 hours).

Thus, a coin type secondary battery was completed.

When the secondary battery is produced, as shown in Tables 1 and 2, the average particle size D (μm) and the weight average molecular weight M are changed respectively to change the success or failure of the appropriate relationship. The measurement procedures of the average particle size D (μm) and the weight average molecular weight M are as described above.

### [Evaluation on Battery Characteristics]

Charge-discharge characteristics were evaluated as battery characteristics, and the results shown in Tables 1 and 2 were obtained. In this case, the physical properties (application characteristics and fluidity characteristics) of the positive electrode mixture slurry affecting the battery characteristics were also evaluated, and the results shown in Tables 1 and 2 were obtained.

### (Application Characteristics)

After the positive electrode mixture slurry was squeegeed on the surface of a grinding gauge (particle size measuring instrument (grinding gauge) single groove grinding meter, which is manufactured by TP GIKEN), the state of the positive electrode mixture slurry was visually observed to determine the application characteristics of the positive electrode mixture slurry. Specifically, the case where a linear trace did not occur in a region where the scale was 50 μm or more was rated as “A”, and the case where a linear trace occurred in a region where the scale was 50 μm or more was rated as “B”.

### (Fluidity Characteristics)

The positive electrode mixture slurry was stirred (stirring speed=30 rpm), and then the positive electrode mixture slurry was left (leaving time=3 hours). Thus, the B-type viscosity of the positive electrode mixture slurry was measured using a B-type viscometer (B-type viscometer TV-22, which is manufactured by Toki Sangyo Co., Ltd.) to determine the fluidity of the positive electrode mixture slurry. Specifically, the case where the change amount of the B-type viscosity of the positive electrode mixture slurry was less than 3 Pa's was rated as “A”, and the case where the change amount of the B-type viscosity of the positive electrode mixture slurry was 3 Pa's or more was rated as “B”.

### (Charge-Discharge Characteristics)

First, the secondary battery was charged and discharged in an ambient temperature environment (temperature=23° C.), thereby measuring the discharge capacity (discharge capacity at the first cycle). At the time of charging, constant current charging was performed at a current of 0.2 C until the voltage reached 4.2 V, and then constant voltage charging was performed at a voltage of 4.2 V until the current reached 0.05 C. At the time of discharging, constant current discharging was performed at a current of 0.2 C until the voltage reached 3.0 V. Here, 0.2 C refers to a current value at which the battery capacity (theoretical capacity) can be discharged in 5 hours, and 0.05 C refers to a current value at which the battery capacity can be discharged in 20 hours.

After that, the secondary battery was charged and discharged in the same environment, thereby measuring the discharge capacity (discharge capacity at the second cycle). The charge and discharge conditions were the same as the charge and discharge conditions for the first cycle except that the current during discharge was changed to 2 C. Here, 2 C refers to a current value at which the battery capacity can be discharged in 0.5 hours.

Subsequently, the capacity retention rate, which is an index for evaluating charge-discharge characteristics, was calculated based on a calculation formula of capacity retention rate (%)=(discharge capacity at the second cycle/discharge capacity at the first cycle)×100.

Finally, the calculation result of the capacity retention rate was rated. Specifically, the case where the capacity retention rate was 80% was rated as “A”, and the case where the capacity retention rate was less than 80% was rated as “B”.

### (Derivation of Appropriate Relationship)

FIG. 6 shows the correlation between the average particle size D (μm) and the weight average molecular weight M. In FIG. 6, the case where all of the three rating results (application characteristics, fluidity characteristics, and capacity retention rate) are A is indicated by “Good”, the case where two of the three rating results are A is indicated by “Fair”, and the case where all of the three rating results are B is indicated by “Poor”.

In FIG. 6, the boundary between the case where two or more of the three rating results are A (Good and Fair) and the case where all of the three rating results are B (Poor) was examined. As a result, a straight line L representing the boundary (M=135106×D+548936) was obtained. As a result, as an appropriate correlation where two or more of the three rating results are A, the appropriate relationship M≤135106×D+548936 regarding the weight average molecular weight M was derived. In FIG. 6, the range where two or more of the three rating results are A is shaded.

In the “Appropriate relationship” shown in Tables 1 and 2, “Success” indicates that the weight average molecular weight M satisfies the appropriate relationship, and “Failure” indicates that the weight average molecular weight M does not satisfy the appropriate relationship.

TABLE 1

| | Positive | | | | | | | |
|---|---|---|---|---|---|---|---|---|
| | electrode | | | | | | | |
| | active | | | | | | | |
| | material | | | | | | | |
| | particle | | Dispersant | | | | | |
| | | Average | | Weight | | | | |
| | | particle | | average | | | | Capacity |
| | | size D | | molecular | Appropriate | Application | Fluidity | retention |
| | Type | (μm) | Type | weight M | relationship | characteristics | characteristics | rate |
| Example 1 | LFP | 0.6 | CMCNa | 630000 | Success | A | B | A |
| Example 2 | | 0.9 | | 630000 | Success | A | B | A |
| Example 3 | | 4 | | 630000 | Success | A | A | A |
| Example 4 | | 4 | | 870000 | Success | A | A | A |
| Example 5 | | 10 | | 630000 | Success | A | A | A |
| Example 6 | | 10 | | 870000 | Success | A | A | A |
| Example 7 | | 10 | | 1900000 | Success | A | A | A |
| Example 8 | | 15 | | 630000 | Success | A | A | A |
| Example 9 | | 15 | | 870000 | Success | A | A | A |
| Example 10 | | 15 | | 1900000 | Success | A | A | A |
| Example 11 | | 15 | | 2100000 | Success | A | A | A |
| Example 12 | | 23 | | 630000 | Success | A | A | B |
| Example 13 | | 23 | | 870000 | Success | A | A | B |
| Example 14 | | 23 | | 1900000 | Success | A | A | B |
| Example 15 | | 23 | | 2100000 | Success | A | A | B |

TABLE 2

| | Positive | | | | | | | |
|---|---|---|---|---|---|---|---|---|
| | electrode | | | | | | | |
| | active | | | | | | | |
| | material | | | | | | | |
| | particle | | Dispersant | | | | | |
| | | Average | | Weight | | | | |
| | | particle | | average | | | | Capacity |
| | | size D | | molecular | Appropriate | Application | Fluidity | retention |
| | Type | (μm) | Type | weight M | relationship | characteristics | characteristics | rate |
| Comparative | LFP | 0.2 | CMCNa | 630000 | Failure | B | B | B |
| Example 1 | | | | | | | | |
| Comparative | | 0.2 | | 870000 | Failure | B | B | B |
| Example 2 | | | | | | | | |
| Comparative | | 0.6 | | 870000 | Failure | B | B | B |
| Example 3 | | | | | | | | |
| Comparative | | 0.9 | | 870000 | Failure | B | B | B |
| Example 4 | | | | | | | | |
| Comparative | | 0.9 | | 1900000 | Failure | B | B | B |
| Example 5 | | | | | | | | |
| Comparative | | 4 | | 1900000 | Failure | B | B | B |
| Example 6 | | | | | | | | |
| Comparative | | 44 | | 2100000 | Failure | B | B | B |
| Example 7 | | | | | | | | |
| Comparative | | 10 | | 2100000 | Failure | B | B | B |
| Example 8 | | | | | | | | |

As shown in Tables 1 and 2, the application characteristics and fluidity characteristics of the positive electrode mixture slurry and the capacity retention rate of the secondary battery varied depending on the configuration of the plurality of positive electrode active material particles (average particle size D) and the configuration of the dispersant (weight average molecular weight M).

Specifically, when the two conditions were satisfied: the average particle size D was 0.6 μm or more; and the weight average molecular weight M satisfied the appropriate relationship (Examples 1 to 15), good results were obtained in two or more of the three rating results compared with the case where the two conditions were not satisfied (Comparative Examples 1 to 8).

In particular, when the two conditions were satisfied (Examples 1 to 15), with the average particle size D of 23 μm or less, good results were obtained in two or more of the three rating results. In this case, when the average particle size D was 4 to 15 μm (Examples 3 to 11), good results were obtained in all of the three rating results.

### Examples 16 to 20

As shown in Table 3, in the same procedure as in Example 7 except that the content (wt %) of the dispersant in the positive electrode active material layer 21B was changed, a secondary battery was produced, and then the physical properties of the positive electrode mixture slurry and the battery characteristics of the secondary battery were evaluated.

After completion of the secondary battery, the content of the dispersant in the positive electrode active material layer 21B was examined, and it was confirmed that the content of the dispersant in the positive electrode active material layer 21B was as shown in Table 3.

TABLE 3
Positive electrode active material particle (Type = LFP, Average particle size D = 10 μm)

| | Dispersant | | | | | | |
|---|---|---|---|---|---|---|---|
| | | Weight | | | | | |
| | | average | | | | | Capacity |
| | | molecular | Content | Appropriate | Application | Fluidity | retention |
| | Type | weight M | (wt % ) | relationship | characteristics | characteristics | rate |
| Example 16 | CMCNa | 1900000 | 0.4 | Success | A | B | A |
| Example 17 | | | 0.6 | Success | A | A | A |
| Example 7 | | | 1 | Success | A | A | A |
| Example 18 | | | 1.5 | Success | A | A | A |
| Example 19 | | | 2 | Success | A | A | A |
| Example 20 | | | 2.2 | Success | A | A | B |

As shown in Table 3, when the content of the dispersant in the positive electrode active material layer 21B was changed, good results were obtained in two or more of the three rating results. In this case, particularly when the content of the dispersant in the positive electrode active material layer 21B was 0.6 to 2 wt % (Examples 7 and 17 to 19), good results were obtained in all of the three rating results.

### Examples 21 to 26

As shown in Table 4, in the same procedure as in Example 7 except that the content (wt %) of the positive electrode binder in the positive electrode active material layer 21B was changed, a secondary battery was produced, and then the physical properties of the positive electrode mixture slurry and the battery characteristics of the secondary battery were evaluated.

After completion of the secondary battery, the content of the positive electrode binder in the positive electrode active material layer 21B was examined, and it was confirmed that the content of the positive electrode binder in the positive electrode active material layer 21B was as shown in Table 4.

TABLE 4
Positive electrode active material particle
(Type = LFP, Average particle size D = 10 μm)
Dispersant (Type = CMCNa, Weight average
molecular weight M = 1900000, Content = 1 wt % )

| | Positive | | | | | |
|---|---|---|---|---|---|---|
| | electrode | | | | | |
| | binder | | | | | Capacity |
| | | Content | Appropriate | Application | Fluidity | retention |
| | Type | ( wt % ) | relationship | characteristics | characteristics | rate |
| Example 21 | CAA | 0.2 | Success | A | A | B |
| Example 22 | | 0.5 | Success | A | A | A |
| Example 23 | | 1 | Success | A | A | A |
| Example 24 | | 2 | Success | A | A | A |
| Example 7 | | 3 | Success | A | A | A |
| Example 25 | | 4 | Success | A | A | A |
| Example 26 | | 6 | Success | A | A | B |

As shown in Table 4, when the content of the positive electrode binder in the positive electrode active material layer 21B was changed, good results were obtained in two or more of the three rating results. In this case, particularly when the content of the positive electrode binder in the positive electrode active material layer 21B was 0.5 to 4 wt % (Examples 7 and 22 to 25), good results were obtained in all of the three rating results.

### Examples 27 to 31

As shown in Table 5, in the same procedure as in Example 7 except that the content (wt %) of the positive electrode conductor in the positive electrode active material layer 21B was changed, a secondary battery was produced, and then the physical properties of the positive electrode mixture slurry and the battery characteristics of the secondary battery were evaluated.

After completion of the secondary battery, the content of the positive electrode conductor in the positive electrode active material layer 21B was examined, and it was confirmed that the content of the positive electrode conductor in the positive electrode active material layer 21B was as shown in Table 5.

TABLE 5
Positive electrode active material particle
(Type = LFP, Average particle size D = 10 μm)
Dispersant (Type = CMCNa, Weight average
molecular weight M = 1900000, Content = 1 wt %)

| | Positive | | | | | |
|---|---|---|---|---|---|---|
| | electrode | | | | | |
| | conductor | | | | | Capacity |
| | | Content | Appropriate | Application | Fluidity | retention |
| | Type | (wt % ) | relationship | characteristics | characteristics | rate |
| Example 27 | CB | 0.2 | Success | A | A | B |
| Example 28 | | 0.5 | Success | A | A | A |
| Example 29 | | 1 | Success | A | A | A |
| Example 7 | | 2 | Success | A | A | A |
| Example 30 | | 3 | Success | A | A | A |
| Example 31 | | 4 | Success | A | B | A |

As shown in Table 5, when the content of the positive electrode conductor in the positive electrode active material layer 21B was changed, good results were obtained in two or more of the three rating results. In this case, particularly when the content of the positive electrode conductor in the positive electrode active material layer 21B was 0.5 to 3 wt % (Examples 7 and 28 to 30), good results were obtained in all of the three rating results.

### SUMMARY

From the results shown in Tables 1 to 5, when the positive electrode active material layer 21B contains a plurality of positive electrode active material particles (olivine type iron-containing phosphate compound) and a dispersant (carboxymethylcellulose salt), the average particle size D of the plurality of positive electrode active material particles is 0.6 μm or more, and the weight average molecular weight M of the dispersant satisfies the appropriate relationship, excellent application characteristics and excellent fluidity characteristics were obtained, and an excellent capacity retention rate was obtained. As a result, the positive electrode mixture slurry is improved in application characteristics and fluidity characteristics, and the secondary battery is improved in charge-discharge characteristics. Accordingly, excellent battery characteristics are obtained.

Although the present technology has been described above with reference to an embodiment including examples, the configuration of the present technology is not limited thereto, and therefore can be modified in a variety of ways.

Specifically, a case where the battery structure of the secondary battery is a cylindrical type and a coin type has been described. However, the battery structure of the secondary battery is not particularly limited, and thus may be a laminate film type, a square type, a button type, and the like.

A case where the element structure of the battery element is a winding type has been described. However, the element structure of the battery element is not particularly limited, and may be a laminated type, a zigzag folded type, or the like. In the laminated type, the positive electrode and the negative electrode are laminated on each other, and in the zigzag folded type, the positive electrode and the negative electrode are folded in a zigzag manner.

A case where the electrode reactant is lithium has been described, but the electrode reactant is not particularly limited. Specifically, as described above, the electrode reactant may be other alkali metals such as sodium and potassium, or alkaline earth metals such as beryllium, magnesium, and calcium. In addition, the electrode reactant may be other light metals such as aluminum.

Since the effects described in the present specification are merely examples, the effects of the present technology are not limited to the effects described in the present specification. Therefore, other effects regarding the present technology may be obtained.

The present technology may also take the following configurations according to an embodiment.

<1>

A secondary battery including:
a positive electrode including a positive electrode active material layer;
a negative electrode; and
an electrolytic solution, in which
the positive electrode active material layer includes:
a plurality of positive electrode active material particles; and
a dispersant,
each of the plurality of positive electrode active material particles includes an olivine type iron-containing phosphate compound,
the dispersant includes a carboxymethylcellulose salt,
the plurality of positive electrode active material particles has a volume-based average particle size of 0.6 μm or more, and
the dispersant has a weight average molecular weight in terms of polyethylene oxide/polyethylene glycol that satisfies a relationship represented by a formula (1):

$$M \leq 135106 \times D + 548936 \qquad ( 1 )$$

in which M represents a weight average molecular weight in terms of polyethylene oxide/polyethylene glycol of a dispersant; and D represents a volume-based average particle size of a plurality of positive electrode active material particles.
   <2>

The secondary battery according to <1>, in which the plurality of positive electrode active material particles has the volume-based average particle size of 23 μm or less.

<3>

The secondary battery according to <1> or <2>, in which the plurality of positive electrode active material particles has the volume-based average particle size of 4 μm or more and 15 μm or less.

<4>

The secondary battery according to any one of <1> to <3>, in which in the positive electrode active material layer, the dispersant is contained in an amount of 0.6 wt % or more and 2 wt % or less.

<5>

The secondary battery according to any one of <1> to <4>, in which
the olivine type iron-containing phosphate compound further includes one kind or two or more kinds of transition metal elements (excluding iron) as a constituent element, and
in the olivine type iron-containing phosphate compound, the iron is contained in an amount of 10 parts by mol or more and 90 parts by mol or less with respect to 100 parts by mol of a total amount of the iron and each of the one kind or two or more kinds of transition metal elements.
   <6>

The secondary battery according to any one of <1> to <5>, in which the carboxymethylcellulose salt includes sodium carboxymethylcellulose.

<7>

The secondary battery according to any one of <1> to <6>, in which
the positive electrode active material layer further contains a positive electrode binder,
the positive electrode binder includes a copolymer of an acrylic acid ester and acrylonitrile, and
in the positive electrode active material layer, the positive electrode binder is contained in an amount of 0.5 wt % or more and 4 wt % or less.
   <8>

The secondary battery according to any one of <1> to <7>, in which
the positive electrode active material layer further contains a positive electrode conductor,
the positive electrode conductor includes a carbon material, and
in the positive electrode active material layer, the positive electrode conductor is contained in an amount of 0.5 wt % or more and 3 wt % or less.
   <9>

The secondary battery according to any one of <1> to <8>, being a lithium ion secondary battery.

<10>

A positive electrode for a secondary battery, the positive electrode including a positive electrode active material layer, in which
the positive electrode active material layer includes:
a plurality of positive electrode active material particles; and
a dispersant,
each of the plurality of positive electrode active material particles includes an olivine type iron-containing phosphate compound,
the dispersant includes a carboxymethylcellulose salt,
the plurality of positive electrode active material particles has a volume-based average particle size of 0.6 μm or more, and
the dispersant has a weight average molecular weight in terms of polyethylene oxide/polyethylene glycol that satisfies a relationship represented by a formula (1):

$$M \leq 135106 \times D + 548936 \qquad ( 1 )$$

in which M represents a weight average molecular weight in terms of polyethylene oxide/polyethylene glycol of a dispersant; and D represents a volume-based average particle size of a plurality of positive electrode active material particles.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a positive electrode active material layer;
a negative electrode; and
an electrolytic solution, wherein
the positive electrode active material layer includes:
a plurality of positive electrode active material particles; and
a dispersant,
each of the plurality of positive electrode active material particles includes an olivine type iron-containing phosphate compound,
the dispersant includes a carboxymethylcellulose salt,
the plurality of positive electrode active material particles has a volume-based average particle size of 0.6 μm or more, and
the dispersant has a weight average molecular weight in terms of polyethylene oxide/polyethylene glycol that satisfies a relationship represented by a formula (1):
$$M \leq 135106 \times D + 548936 \qquad ( 1 )$$
wherein M represents a weight average molecular weight in terms of polyethylene oxide/polyethylene glycol of a dispersant; and D represents a volume-based average particle size of a plurality of positive electrode active material particles.

2. The secondary battery according to claim 1, wherein the plurality of positive electrode active material particles has the volume-based average particle size of 23 μm or less.

3. The secondary battery according to claim 1, wherein the plurality of positive electrode active material particles has the volume-based average particle size of 4 μm or more and 15 μm or less.

4. The secondary battery according to claim 1, wherein in the positive electrode active material layer, the dispersant is contained in an amount of 0.6 wt % or more and 2 wt % or less.

5. The secondary battery according to claim 1, wherein
the olivine type iron-containing phosphate compound further includes one kind or two or more kinds of transition metal elements (excluding iron) as a constituent element, and
in the olivine type iron-containing phosphate compound, the iron is contained in an amount of 10 parts by mol or more and 90 parts by mol or less with respect to 100 parts by mol of a total amount of the iron and each of the one kind or two or more kinds of transition metal elements.

6. The secondary battery according to claim 1, wherein the carboxymethylcellulose salt includes sodium carboxymethylcellulose.

7. The secondary battery according to claim 1, wherein
the positive electrode active material layer further contains a positive electrode binder,
the positive electrode binder includes a copolymer of an acrylic acid ester and acrylonitrile, and
in the positive electrode active material layer, the positive electrode binder is contained in an amount of 0.5 wt % or more and 4 wt % or less.

8. The secondary battery according to claim 1, wherein
the positive electrode active material layer further contains a positive electrode conductor,
the positive electrode conductor includes a carbon material, and
in the positive electrode active material layer, the positive electrode conductor is contained in an amount of 0.5 wt % or more and 3 wt % or less.

9. The secondary battery according to claim 1, being a lithium ion secondary battery.

10. A positive electrode for a secondary battery, the positive electrode comprising a positive electrode active material layer, wherein
the positive electrode active material layer includes:
a plurality of positive electrode active material particles; and
a dispersant,
each of the plurality of positive electrode active material particles includes an olivine type iron-containing phosphate compound,
the dispersant includes a carboxymethylcellulose salt,
the plurality of positive electrode active material particles has a volume-based average particle size of 0.6 μm or more, and
the dispersant has a weight average molecular weight in terms of polyethylene oxide/polyethylene glycol that satisfies a relationship represented by a formula (1):
$$M \leq 135106 \times D + 548936 \qquad ( 1 )$$
wherein M represents a weight average molecular weight in terms of polyethylene oxide/polyethylene glycol of a dispersant; and D represents a volume-based average particle size of a plurality of positive electrode active material particles.
